(19) United States
(12) Patent Application Publication
(10) Pub. No.: US 2011/0169872 A1
(43) Pub. Date: Jul. 14, 2011

(54) Display apparatus and display driving method

(75) Inventors: Hideki Sugimoto, Kanagawa (JP); Naobumi Toyomura, Kanagawa (JP)

(73) Assignee: Sony Corporation, Tokyo (JP)

(21) Appl. No.: 12/926,423

(22) Filed: Nov. 17, 2010

(30) Foreign Application Priority Data
Jan. 14, 2010 (JP) 2010-005965

(51) Int. Cl. G09G 5/10; G09G 3/30

(52) U.S. Cl. 345/690; 345/77

(57) ABSTRACT

A display apparatus includes: a pixel array in which pixel circuits each having a light emitting device, a drive transistor, and a retention capacity are arranged in a matrix; a signal selector supplying a video signal voltages to signal lines arranged in columns on the pixel array; a drive control scanner providing power supply pulses to power supply control lines arranged in rows on the pixel array and applying drive voltages to the transistors; and a write scanner providing scan pulses to writing control lines arranged in rows on the pixel array and executing input of the video signal voltages to the pixel circuits. A threshold correction of setting a gate-source voltage of the transistor to a threshold voltage of the transistor and an input of the video signal voltage from the signal line to between the gate and the source of the transistor are controlled by the scan pulse of the row of the pixel circuit and the scan pulse of the previous row of the pixel circuit.

### BACKGROUND OF THE INVENTION

1. Field of the Invention

The present invention relates to a display apparatus having a pixel array in which pixel circuits are arranged in a matrix and a display driving method therefor, and, for example, relates to a display apparatus using organic electroluminescence devices (organic EL devices) as light emitting devices.

2. Description of the Related Art

For example, as disclosed in JP-A-2003-255856 and JP-A-2003-271095, image display apparatuses using organic EL devices for pixels have been developed. Since the organic EL devices are self-emitting devices, the apparatuses have advantages that visibility of images is higher, backlighting is not necessary, the response speed is higher, etc. compared to a liquid crystal display, for example. Further, the brightness levels (gray levels) of the respective light emitting devices can be controlled by the values of currents flowing therein (so-called current-controlled type).

In an organic EL display, like the liquid crystal display, there are a simple matrix system and an active matrix system as driving systems therefor. The former is simple in structure, however, has a problem that realization of a large and high-definition display is difficult or the like, and thus, currently, the active matrix system is actively developed. This system is to control the currents flowing in the light emitting devices within the respective pixel circuits using active devices (generally, thin-film transistors: TFTs) provided within the pixel circuits.

### SUMMARY OF THE INVENTION

For the pixel circuit configuration using organic EL devices, improvements in display quality by removing brightness irregularities with respect to each pixel or the like, upsizing of a panel, higher brightness, higher definition, higher frame rate (higher frequency), etc. are strongly demanded.

In view of the demands, various kinds of configurations are being studied. For example, as in JP-A-2007-133282, various proposals for a pixel circuit configuration and operation that can remove the brightness irregularities with respect to each pixel by cancelling variations of the threshold voltages and mobility of the drive transistors with respect to each pixel have been made.

Thus, it is desirable to realize a pixel circuit operation preferable for speeding up by higher frequency, driving at a speed many times higher, or the like as a display apparatus using organic EL devices.

A display apparatus according to an embodiment of the invention includes a pixel array in which pixel circuits each having a light emitting device, a drive transistor that applies a current in response to a gate-source voltage to the light emitting device when a drive voltage is applied between a drain and the source, and a retention capacity that is connected between the gate and the source of the drive transistor and retains a threshold voltage of the drive transistor and an input video signal voltage are arranged in a matrix, a signal selector that supplies the video signal voltages to respective signal lines arranged in columns on the pixel array, a drive control scanner that provides power supply pulses to respective power supply control lines arranged in rows on the pixel array and applies drive voltages to the drive transistors of the pixel circuits, and a write scanner that provides scan pulses to respective writing control lines arranged in rows on the pixel array and executes input of the video signal voltages to the pixel circuits. In each pixel circuit in the pixel array, a threshold correction operation of setting the gate-source voltage of the drive transistor to the threshold voltage of the drive transistor and an input operation of the video signal voltage from the signal line to between the gate and the source of the drive transistor are controlled by the scan pulse of the writing control line of the row of the pixel circuit and the scan pulse of the writing control line of the previous row of the pixel circuit.

Specifically, the pixel circuit has first and second sampling transistors, one being of n-channel type and the other being of p-channel type, that are series-connected between the signal line and the gate of the drive transistor and input the video signal voltage supplied to the signal line to the gate of the drive transistor when both of the transistors are brought into conduction, a reference voltage input transistor of the same channel type as that of the first sampling transistor that is connected between a fixed reference voltage and the gate of the drive transistor and inputs the reference voltage to the gate of the drive transistor when brought into conduction, and a retention capacity that is connected between the gate and the source of the drive transistor and retains the threshold voltage of the drive transistor and the input video signal voltage. Further, conduction of the first sampling transistor of each pixel circuit is controlled by the scan pulse of the writing control line of the row of the pixel circuit, and conduction of the second sampling transistor and the reference voltage input transistor of each pixel circuit is controlled by the scan pulse of the writing control line of the previous row of the pixel circuit.

In this case, in each of the pixel circuits, when the drive control scanner provides the drive voltage to the drive transistor, the second sampling transistor is brought into no conduction and the reference voltage input transistor is brought into conduction by the scan pulse of the writing control line of the previous row of the pixel circuit from the write scanner, and thereby, the threshold correction operation is performed.

Further, the write scanner outputs the scan pulses of the respective rows so that plural threshold correction operations may be performed within one light emission cycle period in the respective pixel circuits.

Furthermore, in each of the pixel circuits, when the signal selector provides the video signal voltage for the pixel circuit to the signal line, the first and the second sampling transistors are brought into conduction and the reference voltage input transistor is brought into no conduction by the scan pulses of the respective writing control lines of the row and the previous row of the pixel circuit, and thereby, the input operation of the video signal voltage is performed.

A display driving method of another embodiment of the invention includes the steps of executing the threshold correction operation of setting the gate-source voltage of the drive transistor to a threshold voltage of the drive transistor for each pixel circuit by the scan pulse of the writing control line of the row of the pixel circuit and the scan pulse of the writing control line of the previous row of the pixel circuit, and further executing an input operation of the video signal voltage from the signal line to between the gate and the source of the drive transistor by the scan pulse of the writing control line of the row of the pixel circuit and the scan pulse of the writing control line of the previous row of the pixel circuit.

In a display apparatus of obtaining light emission gray levels by performing current application in response to the gate-source voltages of the drive transistors to the light emitting devices like in an organic EL display apparatus, image quality is improved by performing threshold correction of cancelling variations of the threshold voltages of the drive transistors. For the purpose, the threshold correction reference voltage provided to the pixel circuits at threshold correction and the video signal voltages as the gray level values to be actually displayed are time-divisionally supplied to the respective pixel circuits using the signal lines.

On the other hand, in the case of faster driving such as high-frame-rate driving, the time divisional driving increases the processing load of the signal selector.

Accordingly, in the embodiments of the invention, the signal selector only supplies the video signal voltages to the signal lines. Further, the threshold correction reference voltage is provided from the fixed power supply. Furthermore, in order that the threshold correction reference voltage may be input to the pixel circuit before the start of light emission of the pixel circuit, the scan pulse of the previous row of the pixel circuit is used.

According to the embodiments of the invention, the signal selector may only supply the video signal voltages to the signal lines, and the time divisional supply with the threshold correction reference voltage is unnecessary. Thereby, even when the pixel driving becomes faster, the processing load of the signal selector is small and there are advantages for faster processing and cost.

In addition, threshold correction using the threshold correction reference voltage is possible and both faster driving and improvements in image quality may be balanced. Further, the control for supply of the threshold correction reference voltage to the pixel circuit uses the scan pulse of the previous row, and any new independent control line configuration is unnecessary and further complexity of the configuration of the pixel array or the like may not be caused.

### BRIEF DESCRIPTION OF THE DRAWINGS

FIG. 1 is an explanatory diagram of a configuration of a display apparatus of an embodiment of the invention;

FIG. 2 is a circuit diagram of a pixel circuit of the embodiment;

FIG. 3 is a circuit diagram of a pixel circuit of a comparative example;

FIG. 4 is an explanatory diagram of a pixel circuit operation in the case where divisional threshold correction is performed;

FIGS. 5A and 5B are equivalent circuit diagrams of a process of one cycle of light emission operation of the pixel circuit of the comparative example;

FIGS. 6A and 6B are equivalent circuit diagrams of the process of one cycle of light emission operation of the pixel circuit of the comparative example;

FIGS. 7A and 7B are equivalent circuit diagrams of the process of one cycle of light emission operation of the pixel circuit of the comparative example;

FIG. 8 is an explanatory diagram of an operation of the pixel circuit of the embodiment;

FIGS. 9A and 9B are equivalent circuit diagrams of a process of one cycle of light emission operation of the pixel circuit of the embodiment;

FIGS. 10A and 10B are equivalent circuit diagrams of the process of one cycle of light emission operation of the pixel circuit of the embodiment;

FIGS. 11A and 11B are equivalent circuit diagrams of the process of one cycle of light emission operation of the pixel circuit of the embodiment; and

FIGS. 12A and 12B are equivalent circuit diagrams of the process of one cycle of light emission operation of the pixel circuit of the embodiment.

### DESCRIPTION OF PREFERRED EMBODIMENTS

As below, an embodiment of the invention will be explained in the following order.
[1. Configurations of Display Apparatus and Pixel Circuit]
[2. Pixel Circuit Operation Considered in Process Reaching the Invention: Divisional Threshold Correction]
[3. Pixel Circuit Operation of Embodiment]

### [1. Configurations of Display Apparatus and Pixel Circuit]

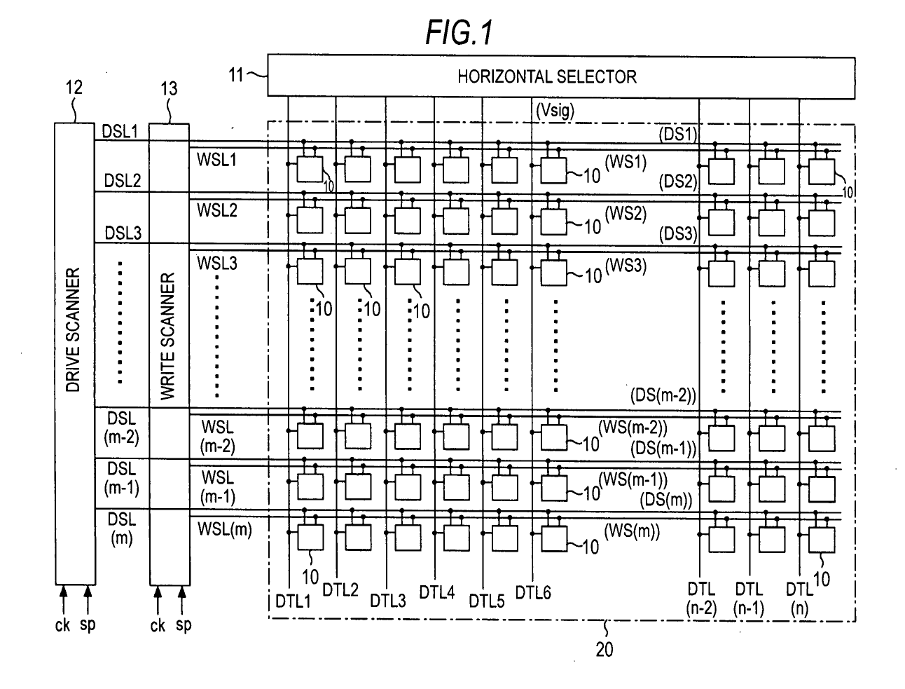

FIG. 1 shows a configuration of an organic EL display apparatus of an embodiment.

The organic EL display apparatus includes pixel circuits 10 using organic EL devices as light emitting devices and performing light emission driving using an active matrix system.

As shown in the drawing, the organic EL display apparatus has an pixel array 20 in which many pixel circuits 10 are arranged in a row direction and a column direction in a matrix (m rows×n columns). Each of the pixel circuits 10 is one of light emitting pixels of R (red), G (green), B (blue), the pixel circuits 10 of the respective colors are arranged with predetermined regularity, and thereby, a color display apparatus is formed.

As a configuration for light emission driving of the respective pixel circuits 10, a horizontal selector 11, a drive scanner 12, and a write scanner 13 are provided.

Further, signal lines DTL1, DTL2, . . . , DTL(n) selected by the horizontal selector 11 for supplying voltages to the pixel circuits 10 in response to signal values (gray level values) of brightness signals as display data are arranged in the column direction on the pixel array. The signal lines DTL1, DTL2, . . . , DTL(n) are provided in the number of columns (n columns) of the pixel circuits 10 arranged in the matrix in the pixel array 20.

Furthermore, on the pixel array 20, writing control lines WSL1, WSL2, . . . , WSL(m) and power supply control lines DSL1, DSL2, . . . , DSL(m) are arranged in the row direction. These writing control lines WSL and the power supply control lines DSL are respectively provided in the number of rows (m rows) of the pixel circuits 10 arranged in the matrix in the pixel array 20.

The writing control lines WSL (WSL1 to WSL(m)) are driven by the write scanner 13.

The write scanner 13 sequentially supplies scan pulses WS (WS1, WS2, . . . , WS(m)) to the respective writing control lines WSL1 to WSL(m) arranged in rows at predetermined preset times, and line-sequentially scan the pixel circuits 10 row by row.

The power supply control lines DSL (DSL1 to DSL(m)) are driven by the drive scanner 12. The drive scanner 12 supplies power supply pulses DS (DS1, DS2, . . . , DS(m)) to the respective power supply control lines DSL1 to DSL(m) arranged in rows according to the line-sequential scan by the write scanner 13. The power supply pulses DS (DS1, DS2, . . . , DS(m)) are pulse voltages switched between two values of a drive voltage Vcc and an initial voltage Vini.

The drive scanner 12 and the write scanner 13 set timing of the scan pulses WS and the power supply pulses DS based on clocks ck and start pulses sp.

The horizontal selector 11 supplies signal line voltages as input signals for the pixel circuits 10 to the signal lines DTL1, DTL2, . . . arranged in the column direction according to the line-sequential scan by the write scanner 13. In the embodiment, the horizontal selector 11 supplies threshold correction reference voltages Vofs and video signal voltages Vsig as the signal line voltages to the respective signal lines.

In the display apparatus of the embodiment, an example of a signal selector in the appended claims is the horizontal selector 11, an example of a drive control scanner is the drive scanner, and an example of a write scanner is the write scanner 13.

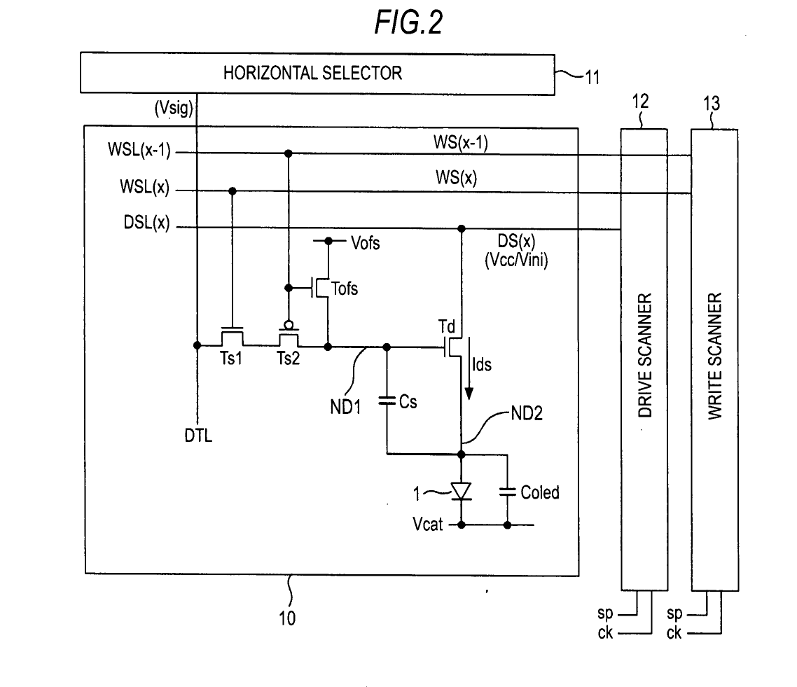

FIG. 2 shows a configuration example of the pixel circuit 10 of the embodiment. The pixel circuits 10 are arranged in a matrix as the pixel circuits 10 in the configuration of FIG. 1.

For simplicity, FIG. 2 shows only one pixel circuit 10 provided in a part in which the signal line DTL, the writing control line WSL(x), and the power supply control line DSL(x) intersect. That is, a certain pixel circuit 10 in the xth row within the pixel array 20 is shown.

The pixel circuit 10 includes an organic EL device 1 as a light emitting device, a retention capacity Cs, sampling transistors Ts1, Ts2, a drive transistor Td, and a reference voltage input transistor Tofs. A capacity Coled is a parasitic capacity of the organic EL device 1.

The sampling transistor Ts1, the drive transistor Td, and the reference voltage input transistor Tofs include n-channel thin-film transistors (TFTs), and the sampling transistor Ts2 includes a p-channel TFT.

The retention capacity Cs has one terminal connected to the source (node ND2) of the drive transistor Td and the other terminal connected to the gate (node ND1) of the same drive transistor Td.

The light emitting device of the pixel circuit 10 is the organic EL device 1 having a diode structure, for example, and has an anode and a cathode. The anode of the organic EL device 1 is connected to the source of the drive transistor Td and the cathode is connected to a predetermined wire (cathode potential Vcat).

The sampling transistors Ts1, Ts2 have their sources and drains series-connected between the signal line DTL and the gate (node ND1) of the drive transistor Td.

That is, the sampling transistor Ts1 has one end of its drain and source connected to the signal line DTL and the other end connected to the sampling transistor Ts2. One end of the drain and the source of the sampling transistor Ts2 is connected to the sampling transistor Ts1 and the other end is connected to the gate (node ND1) of the drive transistor Td.

Therefore, only when both of the sampling transistors Ts1, Ts2 are brought into conduction, the signal line voltage (video signal voltage Vsig) of the signal line DTL is input to the gate of the drive transistor Td.

Further, the gate of the sampling transistor Ts1 is connected to the writing control line WSL(x) corresponding to the row of the pixel circuit 10.

On the other hand, the gate of the sampling transistor Ts2 is connected to the writing control line WSL(x-1) corresponding to the previous row of the row the pixel circuit 10.

The drain of the drive transistor Td is connected to the power control line DSL.

Further, the reference voltage input transistor Tofs has one end of its drain and source connected to a fixed power supply line of a reference voltage Vofs and the other end connected to the gate (node ND1) of the same drive transistor Td.

The gate of the reference voltage input transistor Tofs is connected to the writing control line WSL(x-1) corresponding to the previous row ((x-1)th row) of the row of the pixel circuit 10.

The reference voltage reference input transistor Tofs is an n-channel TFT, the sampling transistor Ts2 is a p-channel TFT, and they have their gate in common connected to the WSL(x-1), and thus, the reference voltage reference input transistor Tofs and the sampling transistor Ts2 are not brought into conduction at the same time.

The light emission driving of the organic EL device 1 is basically as follows.

At the time when the video signal voltage Vsig is applied to the signal line DTL, the sampling transistors Ts1, Ts2 are brought into conduction by the scan pulses WS(x), WS(x-1) provided from the write scanner 13 by the writing control lines WSL(x), WSL(x-1). Thereby, the video signal voltage Vsig from the signal line DTL is written in the retention capacity Cs.

The drive transistor Td allows a current Ids to flow in the organic EL device 1 by the current supply from the power control line DSL provided with the drive potential Vcc by the drive scanner 12, and allows the organic EL device 1 to emit light.

In this regard, the current Ids takes a value in response to a gate-source voltage Vgs of the drive transistor Td (value in response to the voltage retained in the retention capacity Cs), and the organic EL device 1 emits light with brightness in response to the current value.

That is, in the case of the pixel circuit 10, the gate application voltage of the drive transistor Td is changed by writing of the video signal voltage Vsig from the signal line DTL in the retention capacity Cs, and thereby, the current value flowing in the organic EL device 1 is controlled and the gray level of light emission is obtained.

Since the drive transistor Td is designed to constantly operate in a saturated region, the drive transistor Td serves as a constant-current source having a value shown in the following equation (1).

Ids=(1/2)·μ·(W/L)·Cox·(Vgs−Vth)² (1)

Ids indicates a current flowing between the drain and the source of the transistor operating in the saturated region, μ indicates mobility, W indicates a channel width, L indicates a channel length, Cox indicates a gate capacity, and Vth indicates a threshold voltage of the drive transistor Td.

As is clear from the equation (1), the drain current Ids is controlled by the gate-source voltage Vgs in the saturated region. Since the gate-source voltage Vgs is held constant, the drive transistor Td operates as a constant-current source and can allow the organic EL device 1 to emit light with constant brightness.

In this manner, basically, in each frame period, the operation of writing the video signal voltage (gray level value) Vsig in the retention capacity Cs is performed in the pixel circuit 10, and thereby, the gate-source voltage Vgs of the drive transistor Td is determined in response to the gray level to be displayed.

Further, the drive transistor Td functions as a constant-current source for the organic EL device 1 by operating in the saturated region, allows a current in response to the gate-source voltage Vgs to flow in the organic EL device 1, and thereby, light is emitted with brightness in response to the gray level value of the video signal in the organic EL device 1 in each frame period.

### [2. Pixel Circuit Operation Considered in Process Reaching the Invention: Divisional Threshold Correction]

Here, for understanding of the invention, a pixel circuit operation considered in the process reaching the invention will be explained. This is the circuit operation including a threshold correction operation and a mobility correction operation for compensation for uniformity deterioration due to variations in threshold values and mobility of the drive transistors Td of the respective pixel circuits 10. Specifically, as the threshold correction operation, an example of performing divisional threshold correction divisionally performed at plural times within a period of one light emission cycle is shown.

In the pixel circuit operation, the threshold correction operation and the mobility correction operation themselves have been performed in related art, and their necessity will briefly be explained.

For example, in a pixel circuit using a polysilicon TFT or the like, the threshold voltage Vth of the drive transistor Td and the mobility μ of the semiconductor thin film forming the channel of the drive transistor Td may change over time. Further, the transistor characteristics of the threshold voltages Vth and the mobility μ may vary from pixel to pixel due to variations in the manufacturing process.

When the threshold voltages Vth and the mobility μ of the drive transistors Td vary from pixel to pixel, the current values flowing in the drive transistors Td vary from pixel to pixel. Accordingly, if the same video signal value (video signal voltage Vsig) is provided to all pixel circuits 10, light emission brightness of the organic EL device 1 varies from pixel to pixel and, as a result, screen uniformity is degraded.

On this account, in the pixel circuit operation, a correction function for variations of the threshold voltages Vth and the mobility μ is provided.

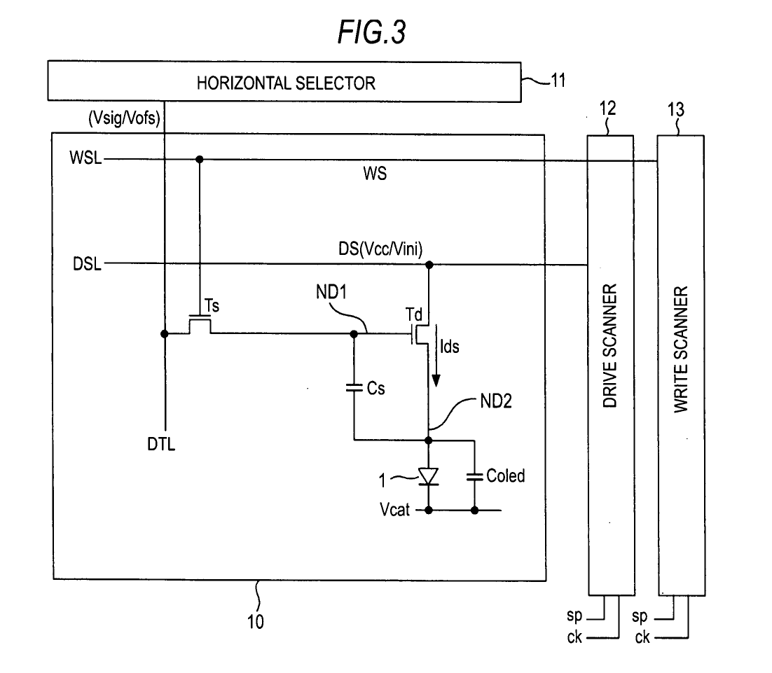

Here, an operation of a general pixel circuit 10 shown in FIG. 3 will be explained.

Compared to the pixel circuit 10 of the embodiment in FIG. 2, none of the second sampling transistor Ts2 or the reference voltage input transistor Tofs is provided.

Further, the horizontal selector 11 is time-divisionally supply the video signal voltage Vsig and the threshold correction reference voltage Vofs for threshold correction operation to the signal line DTL.

The basic light emission operation by the current application from the drive transistor Td to the organic EL device 1 is the same.

That is, at the time when the video signal voltage Vsig is applied to the signal line DTL, the sampling transistor Ts is brought into conduction by the scan pulse WS provided from the write scanner 13 by the writing control line WSL. Thereby, the video signal voltage Vsig from the signal line DTL is written in the retention capacity Cs.

Further, the drive transistor Td functions as a constant-current source for the organic EL device 1 by operating in the saturated region, and allows a current Ids in response to the video signal voltage Vsig (gate-source voltage Vgs) written in the retention capacity Cs to flow in the organic EL device 1. Thereby, light is emitted with brightness in response to the gray level value of the video signal.

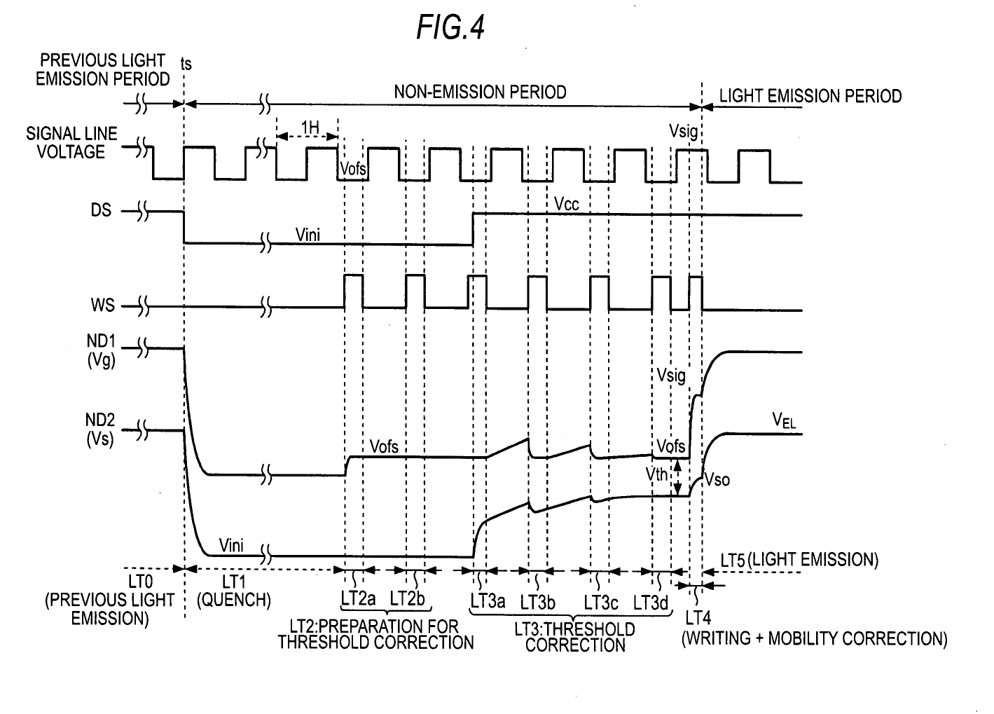

FIG. 4 shows a timing chart of an operation of one light mission cycle (one frame period) of the pixel circuit 10.

In FIG. 4, the signal line voltage that the horizontal selector 11 provides to the signal line DTL is shown. In the case of the operation example, the horizontal selector 11 provides a pulse voltage as the threshold correction reference voltage Vofs and the video signal voltage Vsig to the signal line DTL as the signal line voltage in one horizontal period (1H).

Further, in FIG. 4, a power supply pulse DS supplied from the drive scanner 12 via the power control line DSL is shown. As the power supply pulse DS, the drive voltage Vcc or the initial voltage Vini is provided.

Furthermore, in FIG. 4, the scan pulse WS provided to the gate of the sampling transistor Ts by the write scanner 13 via the writing control line WSL is shown. The n-channel sampling transistor Ts is brought into conduction when the scan pulse WS is set to H-level, and into no conduction when the scan pulse WS is set to L-level.

In addition, in FIG. 4, changes of the gate voltage Vg and the source voltage Vs of the drive transistor Td are shown as the voltages of the nodes ND1, ND2 shown in FIG. 3.

A time point is in the timing chart of FIG. 4 is start timing of one cycle in which the organic EL device 1 as the light emitting device is driven to emit light, for example, one frame period of image display.

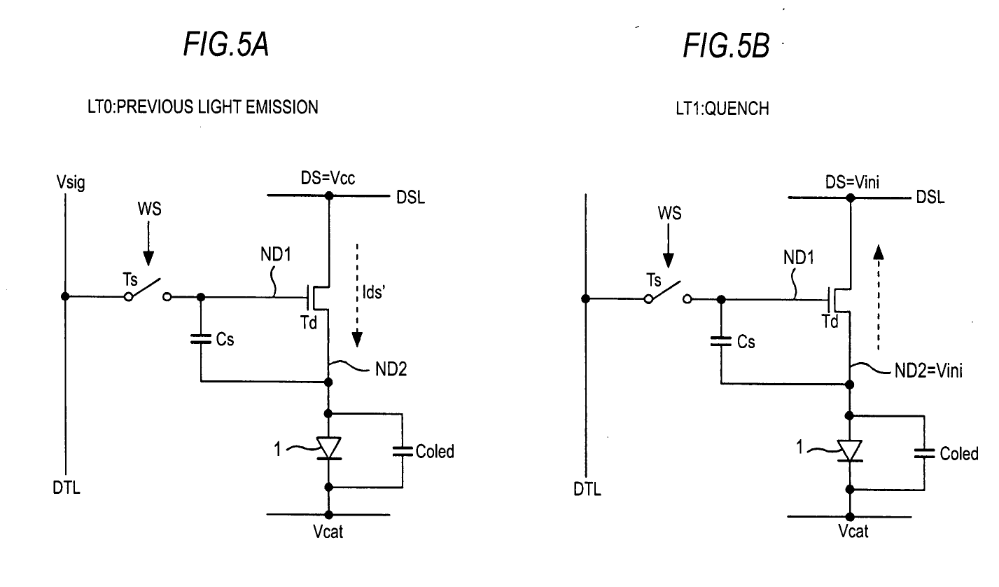

Before the time point ts (period LT0), light emission for the previous frame is performed. An equivalent circuit of the period LT0 is shown in FIG. 5A.

That is, the light emission state of the organic EL device 1 is a state in which the power supply pulse DS is at the drive voltage Vcc and the sampling transistor Ts is off. At this time, the drive transistor Td is set to operate in the saturated region, and thus, a current Ids′ flowing in the organic EL device 1 takes a value shown in the above described equation (1) in response to the gate-source voltage Vgs of the drive transistor Td.

At the time point ts, the operation for light emission in this frame is started.

First, the power supply pulse DS is set to the initial potential Vini. FIG. 5B shows an equivalent circuit of a period LT1.

In this period, the initial potential Vini is smaller than a sum of a threshold voltage Vthe1 and the cathode voltage Vcat of the organic EL device 1, that is, Vini≦Vthe1+Vcat, and thus, the organic EL device 1 is quenched and a non-emission period is started. At this time, the power supply control line DSL serves as the source of the drive transistor Td. Further, the anode (node ND2) of the organic EL device 1 is charged to the initial potential Vini.

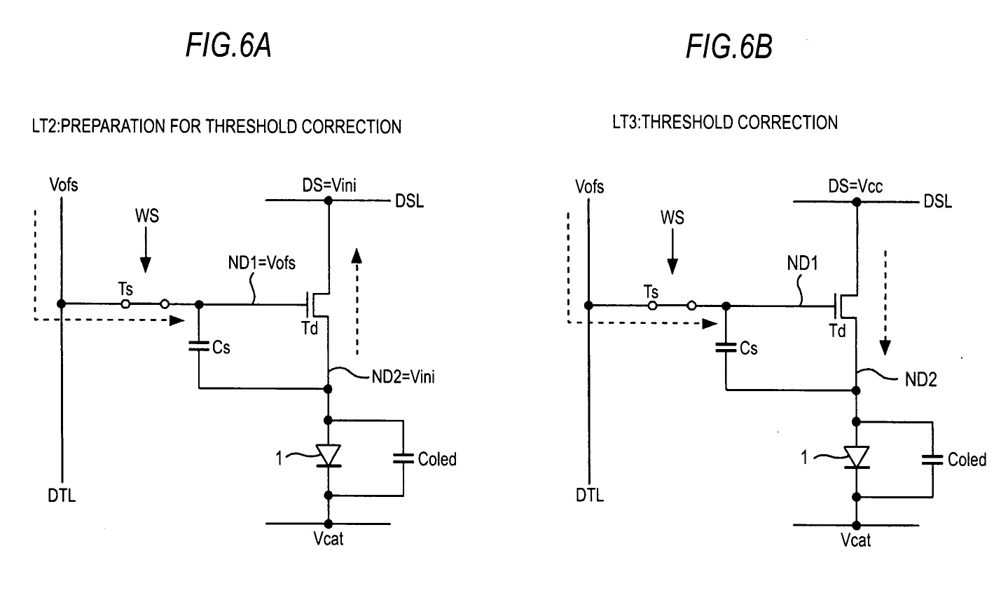

After a fixed period, preparation for threshold correction is made (periods LT2a, LT2b). An equivalent circuit is shown in FIG. 6A.

That is, in the periods LT2a, LT2b, when the potential of the signal line DTL becomes the threshold correction reference voltage Vofs, the scan pulse WS is set to H-level, and the sampling transistor Ts is turned on. The gate (node ND1) of the drive transistor Td is at the threshold correction reference voltage Vofs.

The gate-source voltage Vgs of the drive transistor Td becomes (Vofs−Vini).

It may be impossible to perform the threshold correction operation if the (Vofs−Vini) is not larger than the threshold voltage Vth of the drive transistor Td, and thus, the initial potential Vini and the threshold correction reference voltage Vofs are set to satisfy (Vofs−Vini)>Vth.

That is, as preparation of threshold correction, the gate-source voltage of the drive transistor is made sufficiently larger than the threshold voltage Vth.

Subsequently, threshold correction (Vth correction) is performed. Here, an example of four threshold corrections is shown as periods LT3a to LT3d.

First, as the period LT3a, the first threshold correction (Vth correction) is performed.

In this case, at the time when the signal line voltage is the threshold correction reference voltage Vofs, the write scanner 13 sets the scan pulse WS to H-level, and the drive scanner 12 sets the power supply pulse DS to the drive voltage Vcc. An equivalent circuit is shown in FIG. 6B. In this case, the anode (node ND2) of the organic EL device 1 serves as a source of the drive transistor Td and a current flows therein. Accordingly, the source node rises with the gate (node ND1) of the drive transistor Td fixed to the threshold correction reference voltage Vofs.

As long as the anode potential (potential of the node ND2) of the organic EL device 1 is equal to or less than (Vcat+Vthe1) (the threshold voltage of the organic EL device 1), the current of the drive transistor Td is used for charging the retention capacity Cs and the capacity Coled. The phrase “as long as the anode potential of the organic EL device 1 is equal to or less than (Vcat+Vthe1)” means that the leak current of the organic EL device 1 is substantially smaller than the current flowing in the drive transistor Td.

Accordingly, the potential of the node ND2 (the source potential of the drive transistor Td) rises with time.

The threshold correction basically refers to an operation of setting the gate-source voltage of the drive transistor Td to the threshold voltage Vth. Therefore, the source potential of the drive transistor Td may be raised until the gate-source voltage of the drive transistor Td becomes the threshold voltage Vth.

However, the gate node may be fixed to the threshold correction reference voltage Vofs only in the period in which the signal line voltage=Vofs. Then, depending on the frame rate or the like, a sufficient time for the source potential to rise until the gate-source voltage reaches the threshold voltage Vth may not be taken by one threshold correction operation. On this account, the threshold correction is performed divisionally at plural times.

Accordingly, the threshold correction as the period LT3a is ended before the signal line voltage becomes the video signal voltage Vsig. That is, the write scanner 13 once sets the scan pulse WS to L-level and turns off the sampling transistor Ts.

At this time, both the gate and the source are floated, and a current flows between the drain and the source in response to the gate-source voltage Vgs and bootstrap occurs. That is, as shown in the drawing, the gate potential and the source potential rise.

Next, as the period LT3b, the second threshold correction is performed. That is, when the signal line voltage is equal to the threshold correction reference voltage Vofs, the write scanner 13 sets the scan pulse WS to H-level and turns on the sampling transistor Ts again. Thereby, the gate voltage of the drive transistor Td is set to the threshold correction reference voltage Vofs, the source potential is raised again.

Furthermore, the threshold correction operation pauses. Note that the gate-source voltage of the drive transistor Td is closer to the threshold voltage Vth by the second threshold correction, and thus, the amount of bootstrap in the second pause period is smaller than that in the first pause period.

Then, the third threshold correction is performed in the period LT3c, after another pause, the fourth threshold correction is performed in the period LT3d.

Finally, the gate-source voltage of the drive transistor Td becomes the threshold voltage Vth.

At this time, the source potential (node ND2: anode potential of the organic EL device 1)=(Vofs−Vth)≦(Vcat+Vthe1) (Vcat is the cathode potential and Vthe1 is the threshold voltage of the organic EL device 1).

In the case of FIG. 4, after the period LT3d of the fourth threshold correction, the scan pulse WS is set to L-level and the sampling transistor Ts is turned off, and the threshold correction operation is completed.

Here, the example of performing four threshold corrections is shown, however, the number of times of the divisional threshold correction operation is appropriately determined according to the configuration and the operation of the display apparatus, and, for example, may be two, three, five, or more.

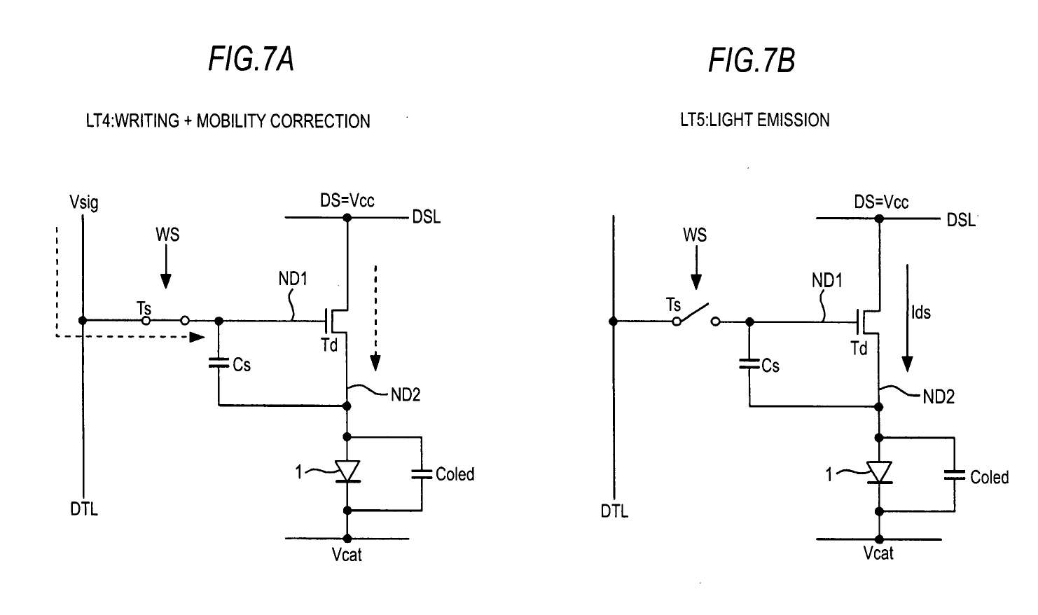

Then, in a period LT 4 in which the signal line voltage is the video signal voltage Vsig, the write scanner 13 sets the scan pulse WS to H-level and writing of the video signal voltage Vsig and mobility correction are performed. That is, the video signal voltage Vsig is input to the gate of the drive transistor Td. An equivalent circuit here is shown in FIG. 7A.

The gate potential of the drive transistor Td is the potential of the video signal voltage Vsig, and a current flows because the power supply control line DSL is at the the drive voltage Vcc and the source potential rises with time.

In this regard, if the source voltage of the drive transistor Td is less than the sum of the threshold voltage Vthel and the cathode voltage Vcat of the organic EL device 1, the current of the drive transistor Td is used for charging the retention capacity Cs and the capacity Coled. That is, the condition is that the leak current of the organic EL device 1 is significantly smaller than the current flowing in the drive transistor Td.

At this time, the threshold correction operation of the drive transistor Td is completed, and the current flowing in the drive transistor Td reflects the mobility μ.

Specifically, if the mobility is larger, the amount of current at this time is larger and the source rises faster. Contrary, if the mobility is smaller, the amount of current is smaller and the source rises slower.

Thereby, in the period LT4 in which the scan pulse WS is at H-level, after the sampling transistor Ts is turned on, the source voltage Vs of the drive transistor Td rises and, when the sampling transistor Ts is turned off, the source voltage Vs becomes Vs0 reflecting the mobility μ. The gate-source voltage Vgs of the drive transistor Td reflects the mobility and becomes smaller (Vgs=(Vsig−Vs0)), and becomes a voltage that completely corrects the mobility after the laps of a fixed period of time.

After the writing of the video signal voltage Vsig and the mobility correction are performed in the above described manner, the gate-source voltage Vgs is fixed and the process moves to bootstrap and light emission (period LT5). FIG. 7B shows an equivalent circuit.

That is, the scan pulse WS is set to L-level, the sampling transistor Ts is turned off, the writing is ended, and then, the organic EL device 1 is allowed to emit light. In this case, the current Ids in response to the gate-source voltage Vgs of the drive transistor Td flows in the organic EL device 1, the potential of the node ND2 rises to a voltage VEL at which the current flows, and the organic EL device 1 emits light. At this time, the sampling transistor Ts is off and the gate (node ND1) of the drive transistor Td similarly rises at the same time of the rising of the potential of the node ND2, and thereby, the gate-source voltage Vgs is kept constant (bootstrap operation).

As described above, the pixel circuit 10 includes the threshold correction operation and the mobility correction operation as one cycle of light emission operation in one frame period, and the operation for light emission of the organic EL device 1 is performed.

By the threshold correction operation, the current in response to the signal potential Vsig may be provided to the organic EL device 1 regardless of variations of the threshold voltage Vth of the drive transistor Td in each pixel circuit 10 and the threshold voltage Vth fluctuation due to fluctuation over time. That is, variations of the threshold voltage Vth in manufacturing or due to changes over time may be cancelled and high quality may be maintained without brightness irregularities or the like on the screen.

Further, the drain current also varies due to the mobility of the drive transistor Td and the image quality becomes lower due to variations in mobility of the drive transistor Td with respect to each pixel circuit 10, however, by the mobility correction, the source potential Vs may be obtained in response to the magnitude of the mobility of the drive transistor Td. As a result, the gate-source voltage Vgs is adjusted to absorb the variations in mobility of the drive transistor Td of each pixel circuit 10, and the image quality degradation due to the variations in mobility may be removed.

Furthermore, as one cycle of pixel circuit operation, the threshold correction operation is divided and performed at plural times is on the demand for higher speed (higher frequency) of the display apparatus.

As the frame rate becomes higher, the operation time of the pixel circuit becomes relatively shorter, and it becomes difficult to secure a continuous threshold correction period (the period in which signal line voltage=threshold correction reference voltage Vofs). Accordingly, a necessary period as the threshold correction period is secured by time-divisionally performing the threshold correction operation in the above described manner, and the gate-source voltage of the drive transistor Td is converged on th threshold voltage Vth.

However, there are the following disadvantages with the faster driving.

As known from the signal line voltage in FIG. 4, the horizontal selector 11 time-divisionally outputs the video signal voltage Vsig and the threshold correction reference voltage Vofs to the signal line DTL in one horizontal period.

As the driving speed becomes higher by higher frame rate or the like, one horizontal period becomes shorter, and then, the operation margin of the time-divisional operation of the horizontal selector 11 becomes lower. Further, there are increase in processing load and demand for higher performance of the driver for the signal line DTL within the horizontal selector 11, and they lead to increase in cost.

### [3. Pixel Circuit Operation of Embodiment]

Accordingly, in the embodiment, it is proposed that the horizontal selector 11 may output only the video signal voltage Vsig without the necessity of time-divisional output. Obviously, image deterioration or the like occurring thereby should be avoided. On this account, a configuration that may execute threshold correction by introducing the threshold correction reference voltage Vofs into the pixel circuit using something other than the signal line DTL is employed. Furthermore, the panel configuration is prevented thereby from being complex due to new control lines.

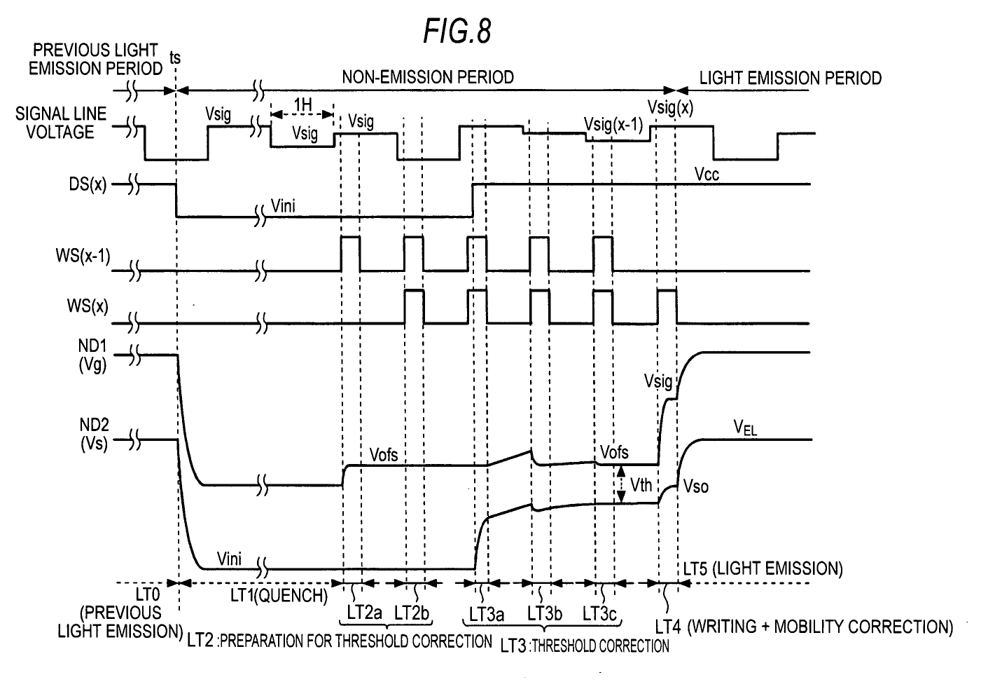

For these purposes, in the embodiment, the pixel circuit 10 employs the above described configuration in FIG. 2. Further, the pixel circuit 10 is operated with driving timing as shown in FIG. 8.

The operation explained in FIG. 8 refers to a threshold correction operation in which the pixel circuit 10 sets the gate-source voltage Vgs of the drive transistor Td to the threshold voltage Vth of the drive transistor Td by the scan pulse WS(x) of the writing control line WSL(x) for the row of the pixel circuit 10 and the scan pulse WS(x-1) of the writing control line WSL(x-1) for the previous row of the pixel circuit 10. Further, the operation refers to an operation in which the input operation of the video signal voltage Vsig from the signal line DTL between the gate and the source of the drive transistor Td by the scan pulses WS(x) and WS(x-1).

FIG. 8 shows a timing chart of an operation of one light emission cycle (one frame period) of operation of the pixel circuit 10.

In FIG. 8, the signal line voltage that the horizontal selector 11 provides to the signal line DTL is shown. In the case of the operation example, the horizontal selector 11 provides a pulse voltage as the signal line voltage and the video signal voltage Vsig to the signal line DTL as the signal line voltage in one horizontal period (1H).

That is, the horizontal selector 11 does not perform output of the threshold correction reference voltage Vofs. As shown in FIG. 2, the threshold correction reference voltage Vofs is introduced from the fixed power supply line via the reference voltage input transistor Tofs into the pixel circuit 10.

Further, in FIG. 8, a power supply pulse DS supplied from the drive scanner 12 via the power control line DSL is shown. As the power supply pulse DS, the drive voltage Vcc or the initial voltage Vini is provided.

Furthermore, in FIG. 8, a scan pulse WS provided to the gate of the sampling transistor Ts by the write scanner 13 via WSL is shown. Here, the scan pulse WS(x) of the writing control line WSL(x) corresponding to the row of the pixel circuit 10 and the scan pulse WS(x-1) of the writing control line WSL(x-1) corresponding to the previous row are shown.

The scan pulses WS in the respective rows are output to the respective writing control lines WSL1 to WSL(m) as shown in FIG. 1 via the shift register within the write scanner 13, for example. Accordingly, the scan pulse WS(x) has a waveform delayed by one horizontal period relative to the scan pulse WS(x-1).

The n-channel sampling transistor Ts1 is brought into conduction when the scan pulse WS(x) is set to H-level, and into no conduction when the scan pulse WS(x) is set to L-level.

The p-channel sampling transistor Ts2 is brought into conduction when the scan pulse WS(x-1) is set to L-level, and into no conduction when the scan pulse WS(x-1) is set to H-level.

The n-channel reference voltage input transistor Tofs is brought into conduction when the scan pulse WS(x-1) is set to H-level, and into no conduction when the scan pulse WS(x-1) is set to L-level.

In addition, in FIG. 8, changes of the gate voltage Vg and the source voltage Vs of the drive transistor Td are shown as the voltages of the nodes ND1, ND2.

The operation in FIG. 8 will be explained. A time point ts in the timing chart of FIG. 8 is start timing of one cycle in which the organic EL device 1 as the light emitting device is driven to emit light, for example, one frame period of image display.

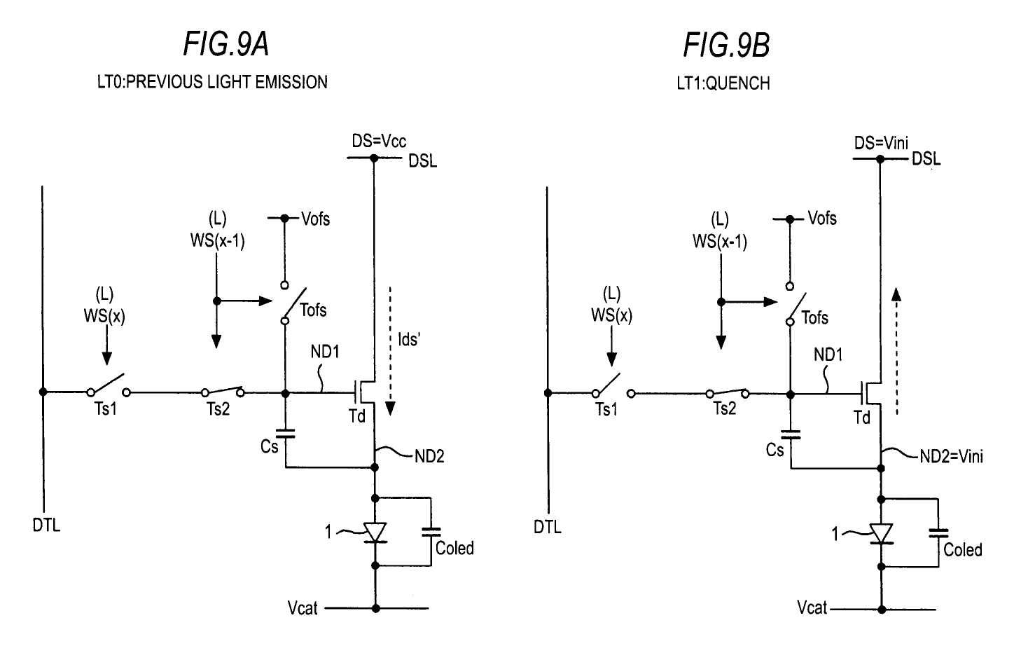

Before the time point ts (period LT0), light emission for the previous frame is performed. An equivalent circuit of the period LT0 is shown in FIG. 9A.

That is, the light emission state of the organic EL device 1 is a state in which the power supply pulse DS is at the drive voltage Vcc and the sampling transistor Ts is off. Though the sampling transistor Ts2 is on, because the sampling transistor Ts1 is off, the node ND1 is separated from the signal line DTL. Further, the reference voltage input transistor Tofs is also off, and the node ND1 is also separated from the fixed power supply line of the threshold correction reference voltage Vofs.

At this time, the drive transistor Td is set to operate in the saturated region, and thus, a current Ids′ flowing in the organic EL device 1 takes a value shown in the above described equation (1) in response to the gate-source voltage Vgs of the drive transistor Td.

At the time point ts, the operation for light emission in this frame is started.

First, the power supply pulse DS is set to the initial potential Vini. In this period, the initial potential Vini is smaller than a sum of a threshold voltage Vthe1 and the cathode voltage Vcat of the organic EL device 1, that is, Vini≦Vthe1+Vcat, and thus, the organic EL device 1 is quenched and a non-emission period is started. As shown in FIG. 9B, at this time, the power supply control line DSL serves as the source of the drive transistor Td, and the anode (node ND2) of the organic EL device 1 is charged to the initial potential Vini.

After a fixed period, preparation for threshold correction is made (periods LT2a, LT2b).

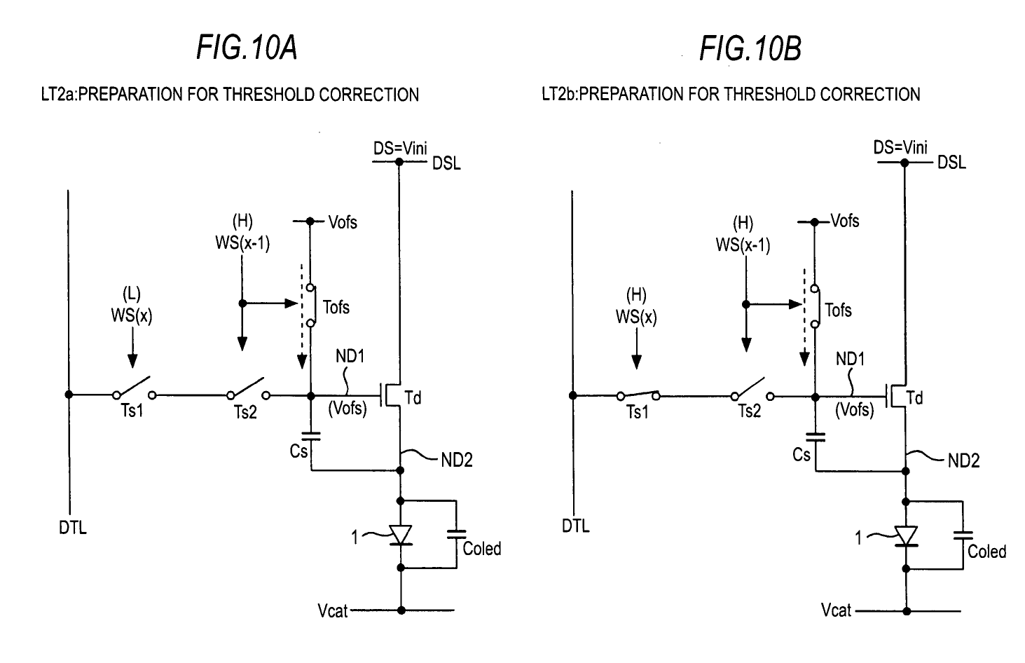

First, in the period LT2a, the scan pulse WS(x-1) is at H-level. As an equivalent circuit shown in FIG. 10A, the reference voltage input transistor Tofs is on. Both of the sampling transistors Ts1, Ts2 are off.

Accordingly, to the gate (node ND1) of the drive transistor Td, the threshold correction reference voltage Vofs from the fixed power supply line is input. Therefore, the gate-source voltage Vgs of the drive transistor Td becomes (Vofs−Vini).

Further, in the period LT2b, the scan pulse WS(x-1) is at H-level. As an equivalent circuit shown in FIG. 10B, the reference voltage input transistor Tofs is on, the sampling transistor Ts1 is on, and the sampling transistor Ts2 is off.

In this case, also, to the gate (node ND1) of the drive transistor Td, the threshold correction reference voltage Vofs from the fixed power supply line is input. Therefore, the gate-source voltage Vgs of the drive transistor Td is (Vofs−Vini).

In the periods LT2a, LT2b, as preparation of threshold correction, the gate-source voltage Vgs of the drive transistor is made sufficiently larger than the threshold voltage Vth. It may be impossible to perform the threshold correction operation if the gate-source voltage Vgs ((Vgs=Vofs−Vini) in this case) is not larger than the threshold voltage Vth of the drive transistor Td, and thus, the initial potential Vini and the threshold correction reference voltage Vofs are set to satisfy (Vofs−Vini)>Vth.

Subsequently, threshold correction (Vth correction) is performed. Here, an example of three threshold corrections is shown as periods LT3a to LT3c.

First, as the period LT3a, the first threshold correction (Vth correction) is performed.

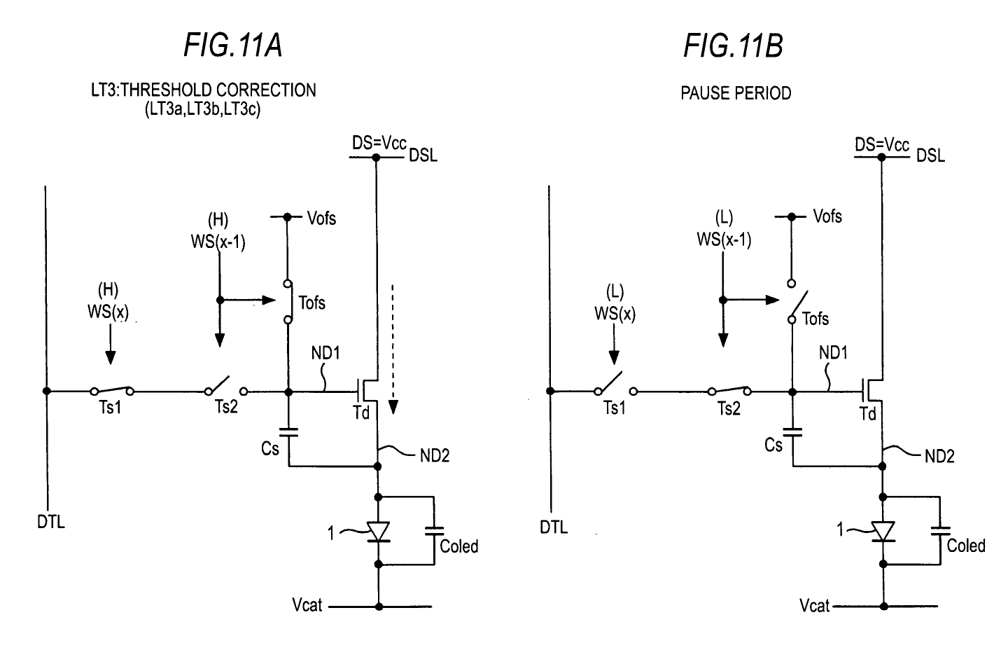

In this case, in the period in which the write scanner 13 sets the scan pulses WS(x), WS(x-1) to H-level, the drive scanner 12 sets the power supply pulse DS to the drive voltage Vcc. An equivalent circuit is shown in FIG. 11A. In this case, the anode (node ND2) of the organic EL device 1 serves as a source of the drive transistor Td and a current flows therein. Accordingly, the source node rises with the gate (node ND1) of the drive transistor Td fixed to the threshold correction reference voltage Vofs.

As long as the anode potential (the potential of the node ND2) of the organic EL device 1 is equal to or less than (Vcat+Vthe1) (the threshold voltage of the organic EL device 1), the current of the drive transistor Td is used for charging the retention capacity Cs and the capacity Coled. The phrase “as long as the anode potential of the organic EL device 1 is equal to or less than (Vcat+Vthe1)” means that the leak current of the organic EL device 1 is substantially smaller than the current flowing in the drive transistor Td.

Accordingly, the potential of the node ND2 (the source potential of the drive transistor Td) rises with time as shown in FIG. 8.

The first threshold correction operation as the period LT3a ends when the scan pulses WS(x), WS(x-1) are at L-level, and the process enters a pause period. An equivalent circuit of the pause period is as shown in FIG. 11B. That is, the sampling transistor Ts1 and the reference voltage input transistor Tofs are turned off and the sampling transistor Ts2 is turned on.

At this time, both the gate and the source of the drive transistor Td are floated, and a current flows between the drain and the source in response to the gate-source voltage Vgs and bootstrap occurs. That is, as shown in FIG. 8, the gate potential Vg and the source potential Vs rise.

Next, as the period LT3b, the second threshold correction is performed when the scan pulses WS(x), WS(x-1) are at H-level. An equivalent circuit becomes the circuit shown in FIG. 11A again.

Thereby, the gate voltage of the drive transistor Td is set to the threshold correction reference voltage Vofs, and the source potential is raised again.

Furthermore, the threshold correction operation pauses when the scan pulses WS(x), WS(x-1) are at L-level. Note that the gate-source voltage of the drive transistor Td is closer to the threshold voltage Vth by the second threshold correction, and thus, the amount of bootstrap in the second pause period is smaller than that in the first pause period.

Then, in the period LT3c, the third threshold correction is performed when the scan pulses WS(x), WS(x-1) are at H-level.

Finally, the gate-source voltage of the drive transistor Td becomes the threshold voltage Vth.

At this time, the source potential (node ND2: anode potential of the organic EL device 1)=(Vofs−Vth)≦(Vcat+Vthe1) (Vcat is the cathode potential and Vthe1 is the threshold voltage of the organic EL device 1).

In the case of FIG. 8, after the period LT3c of the third threshold correction ends, the threshold correction operation is completed.

Then, in a period LT4 in which the signal line voltage is the video signal voltage Vsig(x) for the pixel circuit 10, writing of the video signal voltage Vsig and mobility correction are performed.

As described above, the scan pulses WS(x) and WS(x-1) are pulses shifted from each other by one horizontal period, and, in the period LT4, the scan pulse WS(x) is at H-level and the scan pulse WS(x-1) is at L-level.

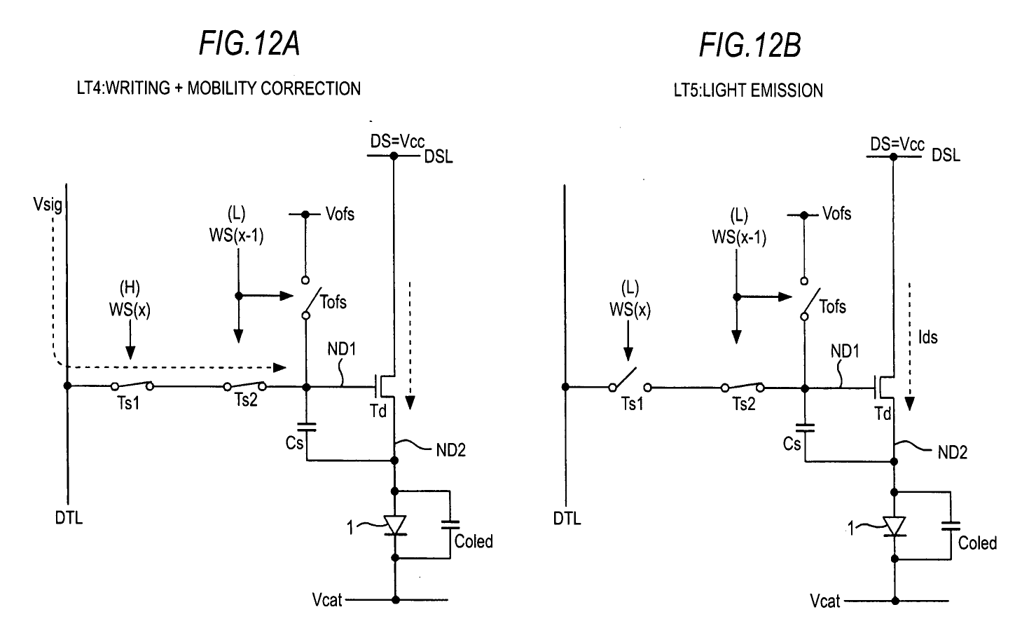

Therefore, as shown in FIG. 12A, both of the sampling transistors Ts1, Ts2 are on and the reference voltage input transistor Tofs is off.

Accordingly, writing of the video signal voltage Vsig(x) from the signal line DTL to the gate of the drive transistor Td is performed.

The gate potential of the drive transistor Td is the potential of the video signal voltage Vsig, and a current flows because the power supply control line DSL is at the the drive voltage Vcc and the source potential rises with time.

In this regard, if the source voltage of the drive transistor Td is less than the sum of the threshold voltage Vthe1 and the cathode voltage Vcat of the organic EL device 1, the current of the drive transistor Td is used for charging the retention capacity Cs and the capacity Coled. The current flowing in the drive transistor Td reflects the mobility μ.

That is, if the mobility is larger, the amount of current at this time is larger and the source rises faster. Contrary, if the mobility is smaller, the amount of current is smaller and the source rises slower. Thereby, in the period LT4 in which the scan pulse WS is at H-level, after the sampling transistor Ts is turned on, the source voltage Vs of the drive transistor Td rises and, when the sampling transistor Ts is turned off, the source voltage Vs becomes Vs0 reflecting the mobility μ. The gate-source voltage Vgs of the drive transistor Td reflects the mobility μ and becomes smaller (Vgs=(Vsig−Vs0)), and becomes a voltage that completely corrects the mobility μ after the lapse of a fixed period of time.

After the writing of the video signal voltage Vsig and the mobility correction are performed in the above described manner, the gate-source voltage Vgs is fixed and the process moves to bootstrap and light emission (period LT5).

That is, the scan pulse WS is set to L-level, the sampling transistor Ts1 is turned off, the writing is ended, and then, the organic EL device 1 is allowed to emit light. An equivalent circuit is as shown in FIG. 12B.

In this case, the current Ids in response to the gate-source voltage Vgs of the drive transistor Td flows, the potential of the node ND2 rises to a voltage VEL at which the current flows in the organic EL device 1, and the organic EL device 1 emits light. At this time, the sampling transistor Ts1 and the reference voltage input transistor Tofs are off and the gate (node ND1) of the drive transistor Td similarly rises at the same time as the rising of the potential of the node ND2, and thereby, the gate-source voltage Vgs is kept constant (bootstrap operation).

As described above, the pixel circuit 10 includes the threshold correction operation and the mobility correction operation as one cycle of light emission operation in one frame period, and the operation for light emission of the organic EL device 1 is performed.

As described above, in the embodiment, conduction of the sampling transistor Ts1 of each pixel circuit 10 is controlled by the scan pulse WS(x) of the writing control line WSL(x) of the row of the pixel circuit 10. Further, conduction of the sampling transistor Ts and the reference voltage input transistor Tofs is controlled by the scan pulse WS(x-1) of the writing control line WSL(x-1) of the previous row of the pixel circuit 10.

Further, in each pixel circuit 10, when the drive scanner 12 provides the drive voltage Vcc to the drive transistor Td, the sampling transistor Ts2 is turned off and the reference voltage input transistor Tofs is turned on by the scan pulse WS(x-1) of the previous row, and the threshold correction operation is performed (period LT3). The threshold correction operation is performed at plural times (periods LT3a, LT3b, LT3c) within a period of one light emission cycle.

Furthermore, in each pixel circuit 10, when the horizontal selector 11 provides the video signal voltage Vsig(x) for the pixel circuit 10 to the signal line DTL, by the scan pulses WS(x), WS(x-1) with respect to the row and the previous row of the pixel circuit, the sampling transistors Ts1, Ts2 are turned on and the reference voltage input transistor is turned off, and the input operation of the video signal voltage Vsig(x) is performed.

According to the above explanation, the horizontal selector 11 may be only necessary to supply the video signal voltage Vsig to the signal line DTL but not necessary to supply the threshold correction reference voltage Vofs. That is, the time-divisional supply as in the case of FIG. 4 is unnecessary. Thereby, even when the speed of pixel driving becomes higher and one horizontal period becomes shorter, the processing load of the horizontal selector 11 does not become excessively larger. That is advantageous for higher processing and the operation margin may be enlarged. Further, that is advantageous with respect to the horizontal selector 11 in cost.

In addition, the threshold correction using the threshold correction reference voltage Vofs is executed and both faster driving and improvements in image quality may be balanced.

Furthermore, since the control for supply of the threshold correction reference voltage Vofs to the pixel circuit 10 is performed using the scan pulse WS(x-1) of the previous row, any new independent control line configuration is unnecessary. Therefore, further complexity of the configuration of the pixel array 20 or the like may not be caused.

The embodiment has been explained above, however, the invention is not limited to the examples.

In the examples, three threshold corrections are performed within one light emission cycle, however, the number of times of the divisional threshold correction operation is appropriately determined according to the configuration and the operation of the display apparatus, and, for example, may be two, four, or more. Further, the invention is not necessarily limited to the system of performing plural threshold correction operations. If threshold correction is completed by one threshold correction operation, the operation may be performed once.

Furthermore, the configuration of the pixel circuit 10 is not limited to that in FIG. 2. For example, n-channel type and p-channel type of the sampling transistors Ts1, Ts2 and the reference voltage input transistors Tofs may be opposite. Obviously, the control logic of the scan pulses WS may be opposite in this case.

In addition, another configuration may be employed as long as the circuit configuration may introduce the threshold correction reference voltage Vofs from the fixed power supply to the node ND1 by the control of the WS(x-1) for the previous row.

The present application contains subject matter related to that disclosed in Japanese Priority Patent Application JP 2010-005965 filed in the Japan Patent Office on Jan. 14, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a pixel array in which pixel circuits each having a light emitting device, a drive transistor that applies a current in response to a gate-source voltage to the light emitting device when a drive voltage is applied between a drain and the source, and a retention capacity that is connected between the gate and the source of the drive transistor and retains a threshold voltage of the drive transistor and an input video signal voltage are arranged in a matrix;
a signal selector that supplies the video signal voltages to respective signal lines arranged in columns on the pixel array;
a drive control scanner that provides power supply pulses to respective power supply control lines arranged in rows on the pixel array and applies drive voltages to the drive transistors of the pixel circuits; and
a write scanner that provides scan pulses to respective writing control lines arranged in rows on the pixel array and executes input of the video signal voltages to the pixel circuits,
wherein, in each pixel circuit in the pixel array, a threshold correction operation of setting the gate-source voltage of the drive transistor to the threshold voltage of the drive transistor and an input operation of the video signal voltage from the signal line to between the gate and the source of the drive transistor are controlled by the scan pulse of the writing control line of the row of the pixel circuit and the scan pulse of the writing control line of the previous row of the pixel circuit.

2. The display apparatus according to claim 1, wherein the pixel circuit has
first and second sampling transistors, one being of n-channel type and the other being of p-channel type, that are series-connected between the signal line and the gate of the drive transistor and input the video signal voltage supplied to the signal line to the gate of the drive transistor when both of the transistors are brought into conduction;
a reference voltage input transistor of the same channel type as that of the first sampling transistor that is connected between a fixed reference voltage and the gate of the drive transistor and inputs the reference voltage to the gate of the drive transistor when brought into conduction; and
a retention capacity that is connected between the gate and the source of the drive transistor and retains the threshold voltage of the drive transistor and the input video signal voltage,
wherein conduction of the first sampling transistor of each pixel circuit is controlled by the scan pulse of the writing control line of the row of the pixel circuit, and
conduction of the second sampling transistor and the reference voltage input transistor of each pixel circuit is controlled by the scan pulse of the writing control line of the previous row of the pixel circuit.

3. The display apparatus according to claim 2, wherein, in each of the pixel circuits, when the drive control scanner provides the drive voltage to the drive transistor, the second sampling transistor is brought into no conduction and the reference voltage input transistor is brought into conduction by the scan pulse of the writing control line of the previous row of the pixel circuit from the write scanner, and thereby, the threshold correction operation is performed.

4. The display apparatus according to claim 3, wherein the write scanner outputs the scan pulses of the respective rows so that plural threshold correction operations may be performed within one light emission cycle period in the respective pixel circuits.

5. The display apparatus according to claim 4, wherein, in each of the pixel circuits, when the signal selector provides the video signal voltage for the pixel circuit to the signal line, the first and the second sampling transistors are brought into conduction and the reference voltage input transistor is brought into no conduction by the scan pulses of the respective writing control lines of the row and the previous row of the pixel circuit, and thereby, the input operation of the video signal voltage is performed.

6. A display driving method for a display apparatus including a pixel array in which pixel circuits each having a light emitting device, a drive transistor that applies a current in response to a gate-source voltage to the light emitting device when a drive voltage is applied between a drain and the source, and a retention capacity that is connected between the gate and the source of the drive transistor and retains a threshold voltage of the drive transistor and an input video signal voltage are arranged in a matrix, a signal selector that supplies the video signal voltages to respective signal lines arranged in columns on the pixel array, a drive control scanner that provides power supply pulses to respective power supply control lines arranged in rows on the pixel array and applies drive voltages to the drive transistors of the pixel circuits; and a write scanner that provides scan pulses to respective writing control lines arranged in rows on the pixel array and executes input of the video signal voltages to the pixel circuits, the method comprising the steps of:
executing a threshold correction operation of setting the gate-source voltage of the drive transistor to the threshold voltage of the drive transistor for each pixel circuit in the pixel array by the scan pulse of the writing control line of the row of the pixel circuit and the scan pulse of the writing control line of the previous row of the pixel circuit; and
further executing an input operation of the video signal voltage from the signal line to between the gate and the source of the drive transistor by the scan pulse of the writing control line of the row of the pixel circuit and the scan pulse of the writing control line of the previous row of the pixel circuit.
